(19) United States
(12) Patent Application Publication
(10) Pub. No.: US 2011/0174838 A1
(43) Pub. Date: Jul. 21, 2011

(54) RETAINER CLIP AND FITTING ASSEMBLY FOR SECURE ENGAGEMENT WITH A FLUID BEARING DEVICE

(76) Inventor: A.A. "Jud" Schroeder, San Antonio, TX (US)

(21) Appl. No.: 12/975,620

(22) Filed: Dec. 22, 2010

Related U.S. Application Data
(60) Provisional application No. 61/295,298, filed on Jan. 15, 2010.

(51) Int. Cl. B67D 7/06; F16L 37/00

(52) U.S. Cl. 222/144.5; 285/305

(57) ABSTRACT

A tube fitting and retainer clip assembly is provided for snugly engaging the tube fitting to the port of a pressure bearing device. The tube fitting contains walls for retaining one or more o-rings thereon. The tube fitting has a channel therethrough. The first end of the tube fitting is adapted to engage a fluid bearing tube. The second end of the fitting, with the o-rings, is adapted to slip into the port of the fluid pressure bearing device. A retainer clip is provided adjacent the port, the retainer clip for sliding between a first position and a second position. The first position allows the fitting to pass through the clip and snugly into the port. The retainer adapted clip is adapted to move longitudinally, in walls of the pressure bearing device. The clip is engaged to the fluid bearing device by walls that allow the clip to slide longitudinally between the first position and the second position, adjacent the port. Removal or insertion of the fitting from the port can occur when the clip is in a first position. A second position will lock the fitting to the clip in a counter bore on the clip, thus holding the fitting in the port.

This application claims the benefit of, incorporates by reference, and priority from: U.S. Provisional Patent Application Ser. No. 61/295,298, filed Jan. 15, 2010; and incorporates by reference U.S. patent application Ser. No. 12/465,283, filed May 13, 2009; and U.S. patent application Ser. No. 12/286,441, filed Sep. 30, 2008.

### FIELD OF THE INVENTION

Retainer clips for use with fluid pressurized devices, such as valves or brixing devices; more particularly, a retainer clip for securely locking a fluid fitting to a fluid pressurized device.

### BACKGROUND OF THE INVENTION

Many mechanical and electromechanical systems are designed to receive and/or expel fluids under pressure. Valves and flow control devices and other pressurized fluid devices, such as those found in U.S. Pat. No. 4,986,449, incorporated herein by reference, for example, as brixing device 18, illustrate systems for handling and transporting pressurized fluids. In particular, the '449 patent illustrates a manifold for receiving a multiplicity of different pressurized fluids, such as syrup and carbonated (soda) water, and for delivery of the pressurized fluid to a remote location, such as a bar gun.

It is seen that a fluid flow device, such as a brixing device, may receive pressurized fluid from a line. Typically, a fitting will be adapted to engage a fluid carrying line and a port on the device in a fluid sealing manner (such as with O-rings). The fitting may be permanently attached, but is typically removably attached to the device. In the '449 patent, for example, input fitting 378 is adapted to removably engage an input port 374, and is secured thereto through the use of a fastening clip 412. Clip 412 engages the body of the device and the input fitting to rigidly and removably locate the fitting, fluid tight in the input port and prevent substantial longitudinal movement of the fitting with respect to the port. Moreover, the retainer clip is adapted to be easily removed from engagement with the fitting in the body of the fluid device, for removal of the fitting (typically with a line attached to it) therefrom. While the clip may slide to removably engage the fitting, it stays captured on the body of the device, so as not to get lost or misplaced.

Most retainer clips or slides allow for the fitting (and the fluid line attached thereto) to be easily removed from the port of the device. Some prior art retainer clips are generally tabular in nature with a FIG. 8 shaped opening, the two bores of the FIG. 8 shaped opening being spaced apart and separated by a waist. In the prior art FIG. 8 slide retainer clip, one would note that one of the two bores.

### OBJECT OF THE INVENTION

It is an object of the present invention to provide for secure engagement of a tube receiving fitting to a fluid pressure bearing device.

### SUMMARY OF THE INVENTION

Applicant discloses a fitting and clip assembly for snugly engaging a fluid carrying line to a fluid pressure bearing device having a cylindrical fitting receiving port and clip retaining walls, the fitting and clip assembly comprising at least some or more of the following elements. The fitting and clip assembly may include a fitting dimensioned for snug receipt into the fitting receiving port, the fitting having a lip with a first diameter slightly smaller than the diameter of the receiving port and a slot with a diameter materially smaller than the diameter of the slot.

A retainer clip is provided for engaging the clip retaining walls of the fluid pressure bearing device, the retainer clip having a first bore and a second bore, the two bores joined by a waste area, the first bore having a diameter of about the diameter of the fitting receiving port, the second bore having a diameter of about the diameter of the slot, as well as a counter bore having a diameter slightly larger than the lip, the counter bore defining a seat for the lip to engage.

### BRIEF DESCRIPTION OF THE DRAWINGS

FIGS. 1 and 2 illustrate a flow control device, such as a valve, manifold or brixing device, which flow control device is designed to receive and/or expel a pressurized fluid.

FIGS. 3A, 3B, and 3C illustrate details of a fitting that may be used with Applicants' novel retainer clip.

FIGS. 4A, 4B, 4C, 4D, 4E, and 4F illustrate various views of Applicants' novel retainer clip.

FIGS. 5A and 5B illustrate the manner in which the fitting and the retainer clip may be lockingly engaged with the slot inner lip of the fitting engaging the seat of the retainer clip.

FIGS. 6A and 6B illustrate the manner in which the clip and fitting are engaged to secure the fitting in the port.

### DETAILED DESCRIPTION OF THE PREFERRED EMBODIMENT

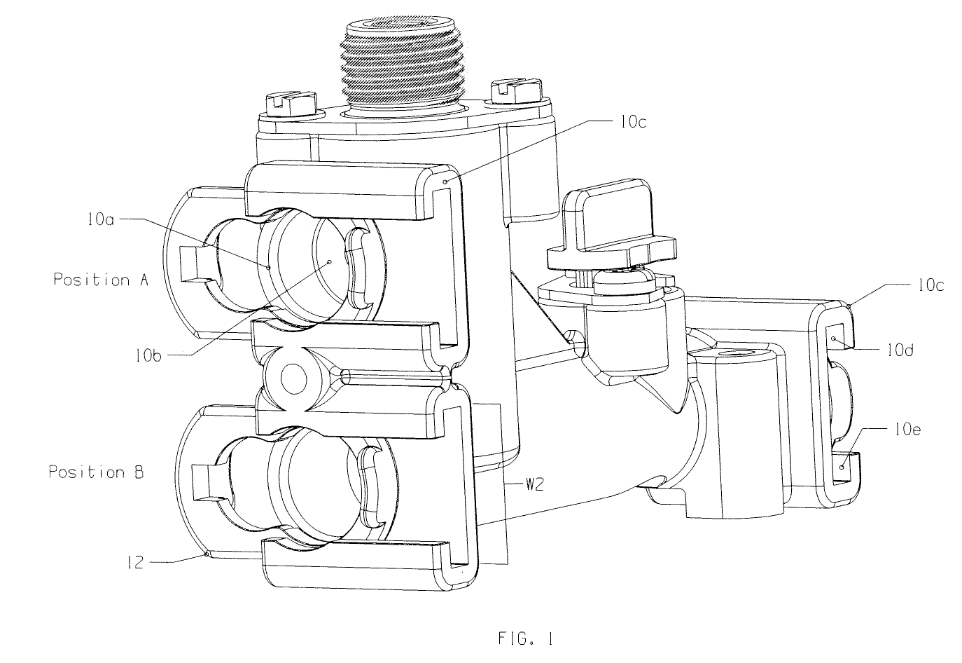

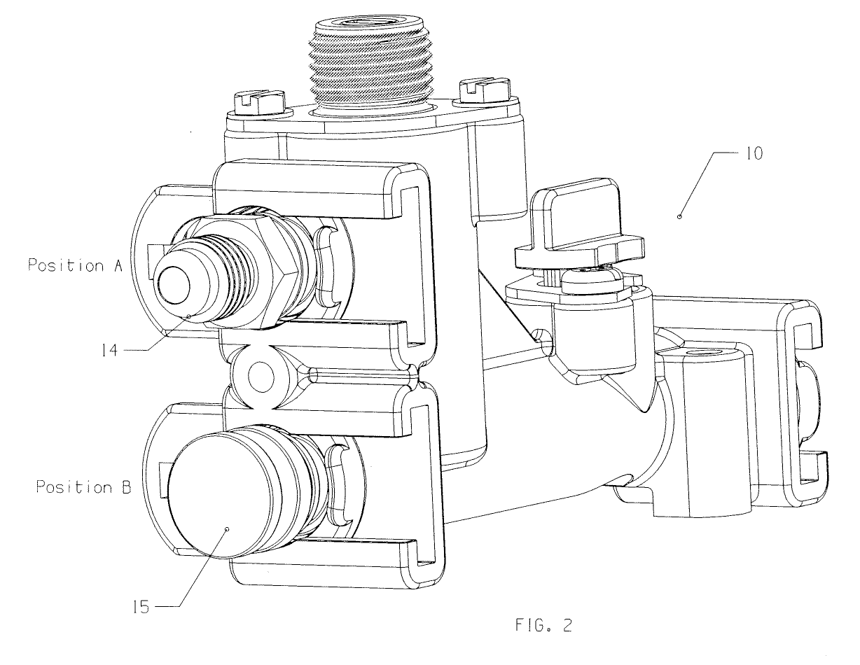

FIGS. 1 and 2 illustrate a flow control device 10, such as a valve, manifold or brixing device, which flow control device is designed to receive and/or expel pressurized fluid. More specifically, FIGS. 1 and 2 illustrate a flow control device (with retainer clip) which includes a port 10a (one port visible in FIG. 1, several are typical), which inlet port includes a fluid inlet 10b. While port 10a is an inlet port, outlet ports are capable of receiving Applicant's novel retainer clip there into as well, inlet port being used for illustration only. Indeed, Applicant's novel retainer clip may be used with any pressurized or unpressurized fitting though it is especially suitable for the former.

Flow control device 10 is seen to include C-shaped member 10c (C-shaped in an end view), which C-shaped member is comprised of a first retaining channel 10d and a second retaining channel 10e. The first and second retaining channels are spaced apart from one another typically above or below the opening defining port 10a, as best seen in FIG. 1. W₂ is the width between the two retainer channels 10d and 10e as seen in FIG. 1.

A retainer clip 12 is seen to engage the C-shaped members in a slideable manner so the retainer clip may slide laterally or side-to-side with respect to the bore defined by port 10a in the manner illustrated in FIG. 1. In FIG. 1, position A illustrates the position of retainer clip with a minor bore 12f (smaller diameter) aligned with the walls defining channel of the intake port 10a. Position B in FIG. 1 illustrates retainer clip 12 in a position wherein a major bore 12g (larger diameter) is adjacent inlet port 10a.

In FIG. 2, position A and position B are illustrated with respect to an upper and a lower port in a valve device. More specifically, in FIG. 2, a fitting 14 is engaged with the upper inlet port 10a as illustrated and, with the minor bore securely engaging a slot in the fitting, it is seen that the fitting 14 is held securely in the inlet port against longitudinal forces, such as fluid pressure trying to unseat the fitting 14. In position B, a plug which may be considered a type of fitting is illustrated and the principle is the same—the plug is slotted and is intended to plug a port and needs to be securely held in a port. Position B in FIG. 2 is illustrated wherein the clip is positioned such that major bore 12g is aligned with port 10a for removal of the fitting.

After examining the structure of retainer clip 12 and fitting 14, we will return to FIGS. 1 and 2 for additional details of the manner in which Applicant's novel retainer clip 12 achieves secure, positive locking of a fitting (including a plug) to a flow control or fluid pressure bearing device 10.

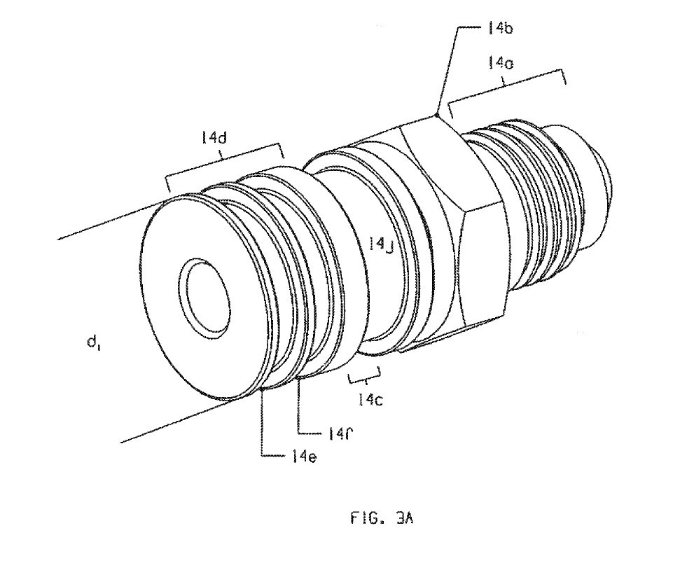

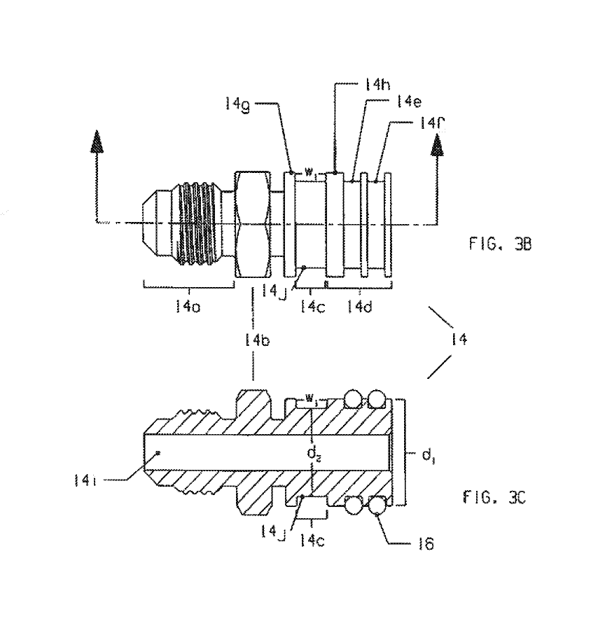

FIGS. 3A, 3B, and 3C illustrate details of fitting 14 that may be used with Applicant's novel retainer clip 12. Fitting 14 is seen to be generally cylindrical with an inner channel 14i extending therethrough. Fitting 14 may include a threaded nose section with threaded nose 14a. The threaded nose would typically be designed for engagement with a threaded female fitting on a fluid bearing line. Nose 14a, however, can be configured in any manner to engage a fluid bearing line or as a plug.

A head 14b may be provided, which head is typically comprised of a polygonal walls, which walls are dimensioned for receipt of a wrench thereon. A wrench may hold the fitting during engagement and disengagement with a female thread as threaded nose 14a is engaged with a line (not shown). Fitting 14 is also seen to include walls defining a retainer slot 14c. The upstanding walls of the slot 14c, in part define slot outer lip 14g and slot inner lip 14h, the distance between these being W₁. That is W₁ is the width of retainer slot 14c.

Fitting 14 is seen to also include a port engaging portion 14d, which port engaging portion 14d may include one or more O-ring bays. Here, port engaging portion 14d includes a pair of O-ring bays designed 14e and 14f, which are dimensioned for the receipt of O-rings 16 therein as illustrated in FIG. 3C.

With further reference to fitting 14, it is seen that an outer diameter of port engaging portion 14d is designed D₁ and an outer diameter of retainer slot 14c is designated D₂. D₂ is smaller than D₁.

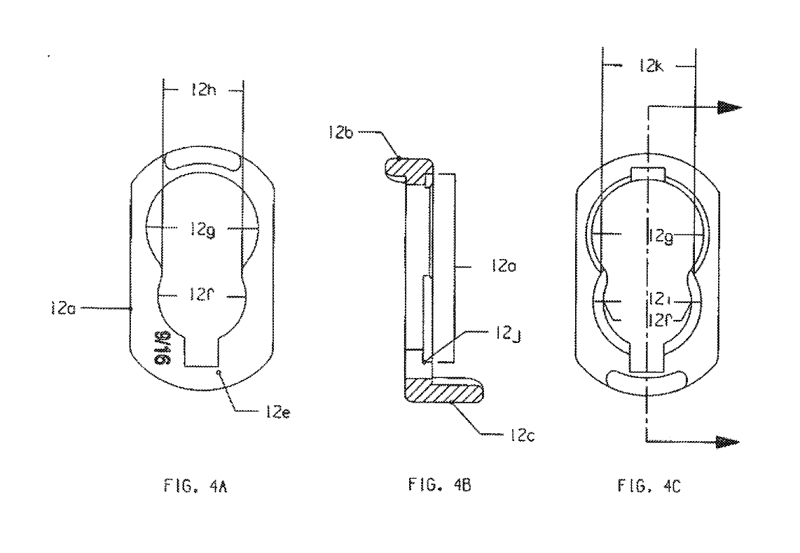

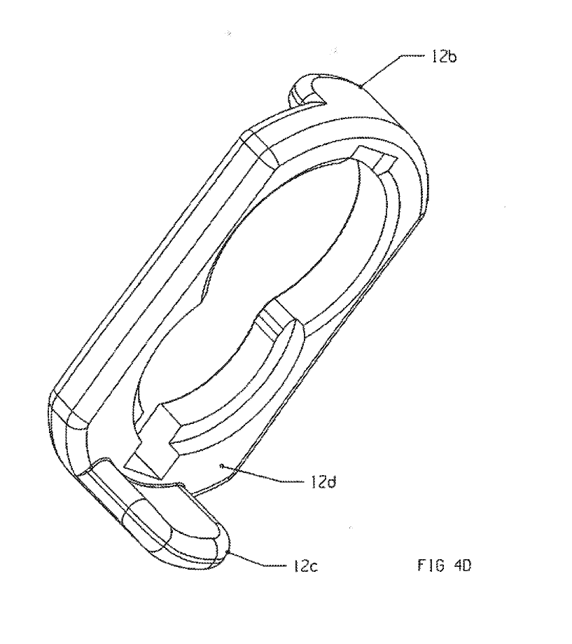

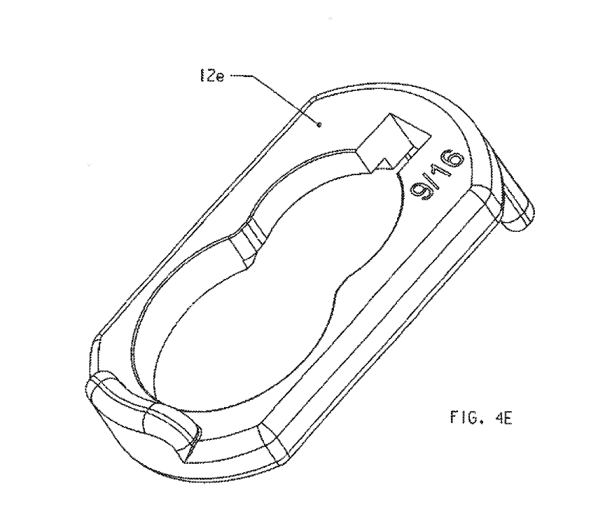

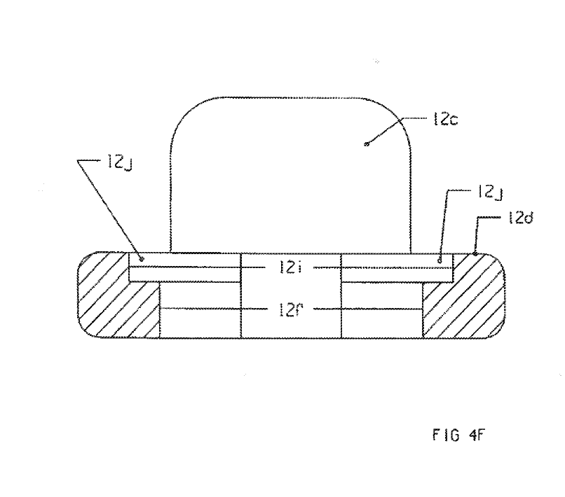

Turning now to FIGS. 4A, 4B, 4C, 4D, 4E, and 4F, various views of Applicant's novel retainer clip 12 are illustrated. Applicant's novel retainer clip 12 is seen to have a tabular body 12a with, typically, a pair of tabs here designated 12b (which may be minor) and 12c (major) are illustrated, which tabs are set at spaced apart ends of the tabular body and project approximately perpendicular thereto in opposite directions (see also FIGS. 1 and 2). Tab 12b/12c are adapted to be grasped between the thumb and forefinger of a user to slide the clip laterally (side-to-side) in the C channels between positions A and B to effectuate fitting engagement and disengagement.

The retainer clip is seen to have an inner face 12d and an outer face 12e. They are spaced apart and dimensioned for snug receipt into the C channels as illustrated in FIGS. 1 and 2. The FIG. 8 opening is provided comprising a minor bore 12f, a major bore 12g, and an outer waist 12h separating the adjacent bores 12f and 12g (see FIG. 4A) and an inner waist 12k separating major bore 12g and a counter bore 121.

The diameter 12g of major bore is slightly larger than D₁ so as to allow receipt of at least the port engaging portion 14d of fitting 14 therethrough and minor bore 12f is dimensioned for snug receipt of bottom walls 14j of fitting 14 thereagainst. Minor bore 12f is provided with counter bore 12i as seen in FIGS. 4D and 4F, for example, which counter bore 12i has a diameter slightly larger than slot inner lip 14h (which is typically about equal to D₁). Counter bore 12i thus creates an “L” shaped annular (partially annular) seat 12j for receipt of slot inner lip 14h thereinto further set forth below.

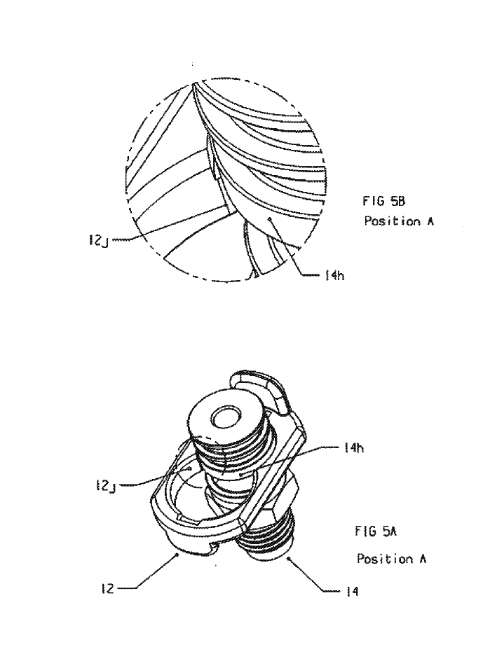

Turning to FIGS. 5A and 5B, the manner in which fitting 14 and retainer clip 12 may be lockingly engaged with slot inner lip 14h engaging seat 12j is illustrated.

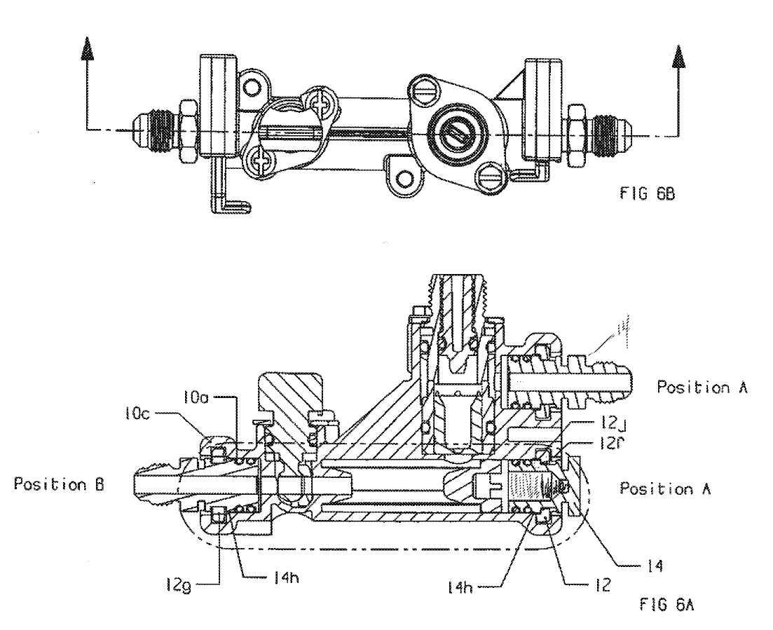

FIGS. 6A and 6B in conjunction with FIGS. 1, 2, 5A, and 5B will illustrate a manner in which the clip and fitting are engaged to secure the fitting in the port. This is typically done when the system is down; that is, not pressurized and no fluid flow. Assume first that the retainer slide 12 is engaged with the device 10 and in position B as illustrated in FIG. 1. Fitting 14 is inserted into major bore 12g until it is fully seated in port 10a as seen on the left side port, position “B” in FIG. 6A. Clip 12a is then slid laterally to the right as seen in FIG. 1, so that it is in the position as illustrated in position A in FIG. 1 (which has the fitting removed for clarity). With the clip in that position, the user will then urge fitting 14 longitudinally outward along the axis of inlet 10a so the inner lip 14h seats into seat 12j as seen in FIGS. 5A, 5B, and 6A, all designated position “A”. In short, position A is with the fitting seated into the counter bore. Even if the user does not manually slide the fitting into the seated position, when the system is pressurized, the hydraulic pressure will seat the fitting against the retainer clip. This is the safety position, the unit is pressurized and the pressure “locks” the fitting in the counter bore of the clip and therefore resists longitudinal or sliding forces on the clip. When the unit is depressurized, one may unseat the fitting by pushing it all the way into the port and sliding the clip longitudinally. Position B is for removal of the fitting from the device and has the major bore 12g adjacent and aligned with the inlet port.

As seen in FIG. 6A, fitting 14 on the lower right of the valve illustrated has an incomplete channel, and takes the form of a plug. That is to say, when the term fitting or tube fitting is used herein, it includes embodiments having a complete inner channel (upper right, FIG. 6A), an incomplete or partial inner channel (lower right, FIG. 6A), or no channel at all (i.e., a plug).

Although the invention has been described in connection with the preferred embodiment, it is not intended to limit the invention's particular form set forth, but on the contrary, it is intended to cover such alterations, modifications, and equivalences that may be included in the spirit and scope of the invention as defined by the appended claims.

1. A fitting and clip assembly for snuggly engaging a fluid carrying line to a fluid pressure bearing device having a cylindrical fitting receiving port and clip retaining walls, the fitting and clip assembly comprising:
a cylindrical fitting dimensioned for snug receipt into the fitting receiving port, the fitting having a lip with a lip diameter slightly smaller than the diameter of the receiving port and a slot adjacent the lip, the slot with a slot diameter less than the lip diameter; and
a retainer clip with walls for slideably engaging the clip retainer walls of the fluid pressure bearing device, the retainer clip having a first bore and a second bore, the two bores joined by a waist area with a waist diameter, the first bore having a diameter of about the diameter of the fitting receiving port, the second bore having a diameter of about the diameter of the slot, the second bore having a counter bore adjacent thereto having the diameter slightly larger than the lip, the counter bore defining a seat to engage the lip, the waist diameter being less than the diameter of the second bore and the counter bore;
wherein the retainer clip is adapted with the fitting fully inserted into the receiving port, to slide between a first position with the first bore adjacent the receiving port and a second position therein, with the fitting fully inserted into the receiving port, the second position wherein the lip lays adjacent the counter bore and wherein the fitting may move longitudinally slightly into the counter bore with the lip engaging the seat.

2. The fitting and clip assembly of claim 1, wherein the fitting has a longitudinal channel therethrough.

3. A fitting and clip assembly for snuggly engaging a fluid carrying line to a fluid pressure bearing device having a cylindrical fitting receiving port and clip retaining walls, the fitting and clip assembly comprising:
a cylindrical fitting heaving a first end and a second end, the second end adapted to receive a tube carrying a fluid therein, the fitting having an “0” ring bay adjacent the first end and a groove and a lip, the groove and the lip between the “0” ring bay and the second end, the lip between the “0” ring bay and the groove, the lip having a diameter just slightly less than the receiving port; and
a retainer clip having a planar section, the planar section having an inner and outer surface and walls defining a bore having a first larger diameter and a bore having a second, smaller diameter, the first and second bores separated by a waist having a waist opening less than the second diameter, a countersunk seat on the inner surface adjacent the second bore and with a diameter sufficient to flushly receive the lip of the fitting;
wherein the groove of the fitting has a diameter between the second, smaller diameter and the waist opening.

4. The fitting and clip assembly of claim 3, wherein the fitting has a longitudinal channel therethrough.

5. A beverage dispensing system comprising:
a bar gun;
a valve and manifold assembly having a multiplicity of fitting receiving ports at an intake end thereof and having a multiplicity of clip retainer walls adjacent the receiving ports;
a python for engaging the bar gun to the valve and manifold assembly;
a multiplicity of tube fittings;
a multiplicity of tubes for engaging the multiplicity of tube fittings;
each tube fitting comprising:
cylindrical, exterior walls including a portion dimensioned for snug receipt into the fitting receiving port, a channel, the fitting having a lip with a lip diameter slightly smaller than the diameter of the fitting receiving port and a slot adjacent the lip, the slot with a slot diameter less than the lip diameter; and
a retainer clip with walls for slideably engaging the clip retainer walls of the valve and manifold assembly, the retainer clip having a first bore and a second bore, the two bores joined by a waist area with a waist diameter, the first bore having a diameter of about the diameter of the fitting receiving port, the second bore having a diameter of about the diameter of the slot, the second bore having a counter bore adjacent thereto having the diameter slightly larger than the lip, the counter bore defining a seat to engage the lip, the waist diameter being less than the diameter of the second bore and the counter bore;
wherein the retainer clip is adapted with the fitting fully inserted into the receiving port, to slide between a first position with the first bore adjacent the receiving port and a second position therein, with the fitting fully inserted into the receiving port, the second position wherein the lip lays adjacent the counter bore and wherein the fitting may move longitudinally slightly into the counter bore with the lip engaging the seat thereof.

6. The beverage dispensing system of claim 5, wherein the fitting has a longitudinal channel therethrough.
